(19) United States
(12) Patent Application Publication
(10) Pub. No.: US 2014/0339284 A1
(43) Pub. Date: Nov. 20, 2014

(54) LINK ARRANGEMENT IN A STAPLER

(71) Applicant: Olle Strååt, Hestra (SE)

(72) Inventor: Olle Strååt, Hestra (SE)

(21) Appl. No.: 14/344,094

(22) PCT Filed: Aug. 21, 2012
(86) PCT No.: PCT/SE2012/000120

§ 371 Date: Mar. 11, 2014

(30) Foreign Application Priority Data
Sep. 13, 2011 (SE) 1100668-1

(51) Int. Cl. B27F 7/30

(52) U.S. Cl. CPC B27F 7/30
USPC 227/143

(57) ABSTRACT

A link arrangement (13) forming part of a stapler (1) in which stapling of a workpiece (34) such as a sheaf of papers is effected, which stapler comprises a frame (2) which has attached to it a drive device (7), a staple magazine (5), a driver (6), an anvil (4) and said link arrangement which is connected to and acted upon by the drive device (7) and which in a reciprocating stapling movement (P) imparts to the driver and the anvil relative to the frame a reciprocating movement in which the driver and the anvil move towards and away from one another, which link arrangement (13) is provided with a scissors link (14) which comprises a connecting spindle (15) and at least four arms (16-19).

### TECHNICAL FIELD

The present invention relates to a link arrangement forming part of a stapler in which stapling of a workpiece such as a sheaf of papers is effected, which stapler comprises a frame which has attached to it a drive device, a staple magazine, a driver, an anvil and said link arrangement which is connected to and acted upon by the drive device and which in a reciprocating stapling movement imparts to the driver and the anvil relative to the frame a reciprocating movement in which the driver and the anvil move towards and away from one another.

### STATE OF THE ART

Staplers provided with link arrangements which in all essentials work in accordance with the function described above are prior art. To cite but a few, they are referred to in patent specifications U.S. Pat. No. 6,820,790, U.S. Pat. No. 4,199,095 and U.S. Ser. No. 11/628,784. A common feature of these prior arrangements is that they comprise a plurality of parts which render them complicated both to manufacture and to assemble. In addition, their movement pattern is not entirely continuous but conducted in sequences such that a number of start sequences occur throughout the movement process. Each of these start sequences causes noise, rendering the stapler's noise level unnecessarily high, and each starting sequence also requires starting energy, resulting in unnecessary load upon the drive device and hence unnecessary energy consumption. A further consequence of these starts is increased wear of constituent parts of the arrangement, not only shortening the stapler's service life but also leading to both higher noise levels and greater energy consumption.

### PROBLEM

There is thus a need for a link arrangement with a movement pattern in which the various sequences follow immediately after one another or each follow one another in such a way that no time gaps occur in the movement process, which arrangement also comprises only a few parts, which parts are easy to manufacture and assemble and do not cause a high noise level or require unnecessary energy, nor when they have become worn do they generate higher noise levels or increased energy requirements.

### SOLUTION

The present invention overcomes the disadvantages indicated above by means of a link arrangement of the kind indicated in the introduction which is characterized by being provided with a scissors link which comprises a connecting spindle and at least four arms.

The invention is also characterized in that the four arms of the scissors link comprise a first arm connected pivotably to the frame and a second arm connected pivotably to the drive device, these arms being situated on a first side of the scissors link, and a third arm connected to the anvil and a fourth arm connected to the driver, these two latter arms being situated on a second side of the scissors link which is opposite to the first side.

The invention is also characterized in that the second arm is divided into first and second elements connected together by a first hinge pin.

The invention is further characterized in that the third arm is divided into third and fourth elements connected together by a second hinge pin.

The invention is also further characterized in that the fourth arm is divided into fifth and sixth elements connected together by a third hinge pin.

In addition, the invention is characterized in that throughout the stapling movement in the height direction the connecting spindle of the scissors link is at a lower level than the connection point of the second arm to the drive device.

### BRIEF DESCRIPTION OF THE DRAWINGS

The invention is described below with reference to the attached drawings, in which

FIG. 1 depicts a stapler provided with the invention, in an initial state,

FIGS. 2-3 are views corresponding to FIG. 1 with the stapler in different states during the stapling movement,

FIG. 4 depicts the stapler in the state of having completed a stapling movement and

FIG. 5 depicts the stapler in a state of having returned to the initial state after completing a stapling movement.

### PREFERRED EMBODIMENT EXAMPLE

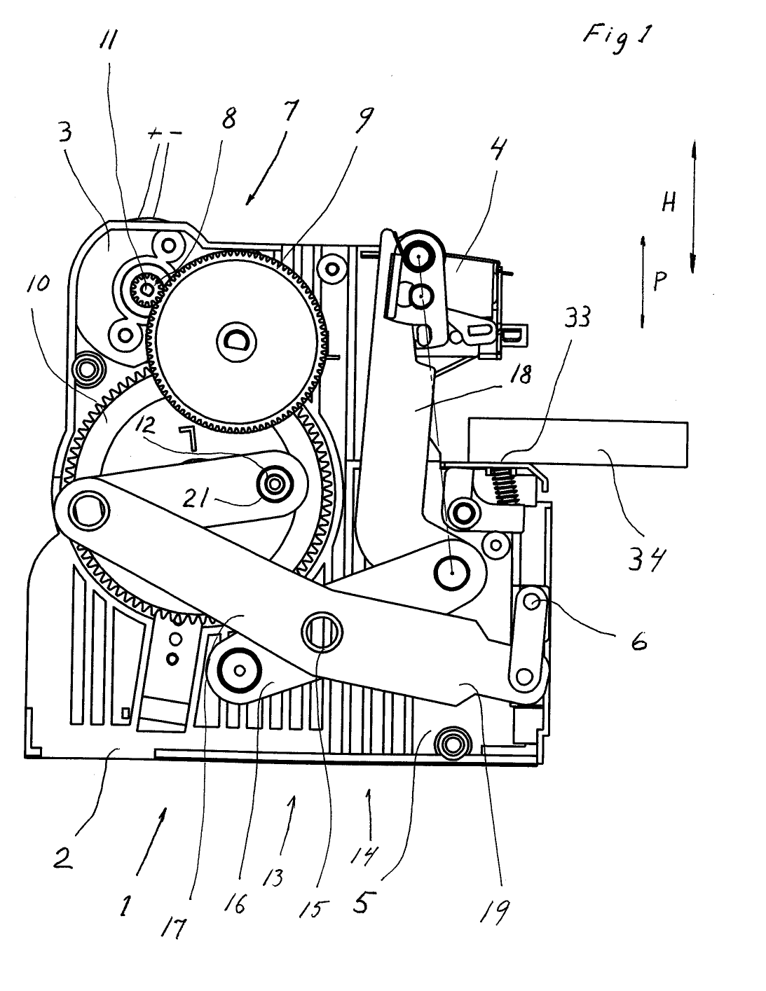

FIG. 1 depicts a stapler 1 in an initial state as seen from the side. It shows the stapler comprising a frame 2 with a height extent indicated by the double arrow H. The frame has attached to it a drive means 3 which may preferably be an electric motor. The frame also has attached to it an anvil 4 which in a way known to one skilled in the art can participate in the reciprocating stapling movement in the direction indicated by the double arrow P. Also situated in the frame is a magazine 5, not clearly depicted in the drawings, which contains staples. The frame also has attached to it a driver 6 not depicted other than its portion connected to the link arrangement, as will be described below. The driver may be situated either in the frame or in the magazine. In either case it is so arranged in a way known to one skilled in the art that it can participate in the reciprocating movement indicated by the double arrow P.

Also situated in the frame is a drive device 7 comprising not only the drive means 3 but also a plurality of gearwheels, of which only a first gearwheel 8, a second gearwheel 9 and a third gearwheel 10 appear in the drawing. The first gearwheel is connected to an output shaft 11 of the drive means 3. The third gearwheel 10 has a connecting spigot 12 attached to it. When the drive means 3 is activated, the shaft 11 and the gearwheels 8-10 rotate, causing the connecting spigot 12 to rotate and to move relative to the height H of the frame in an up and down movement which coincides with the movement indicated by the double arrow P.

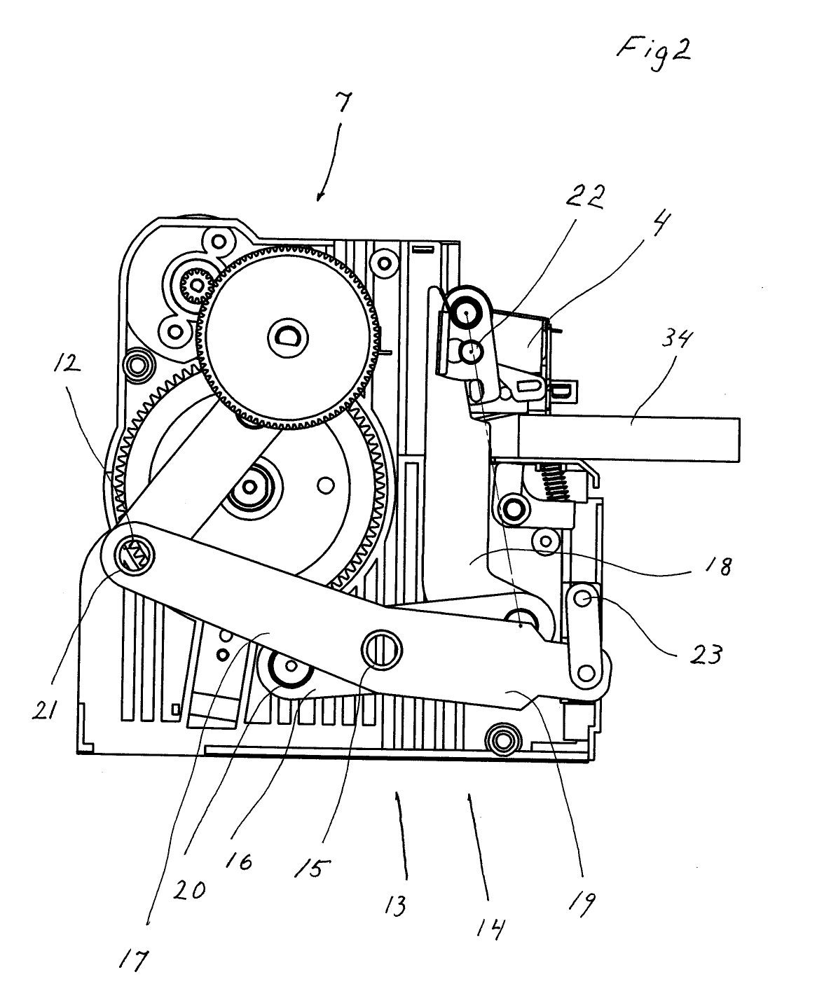

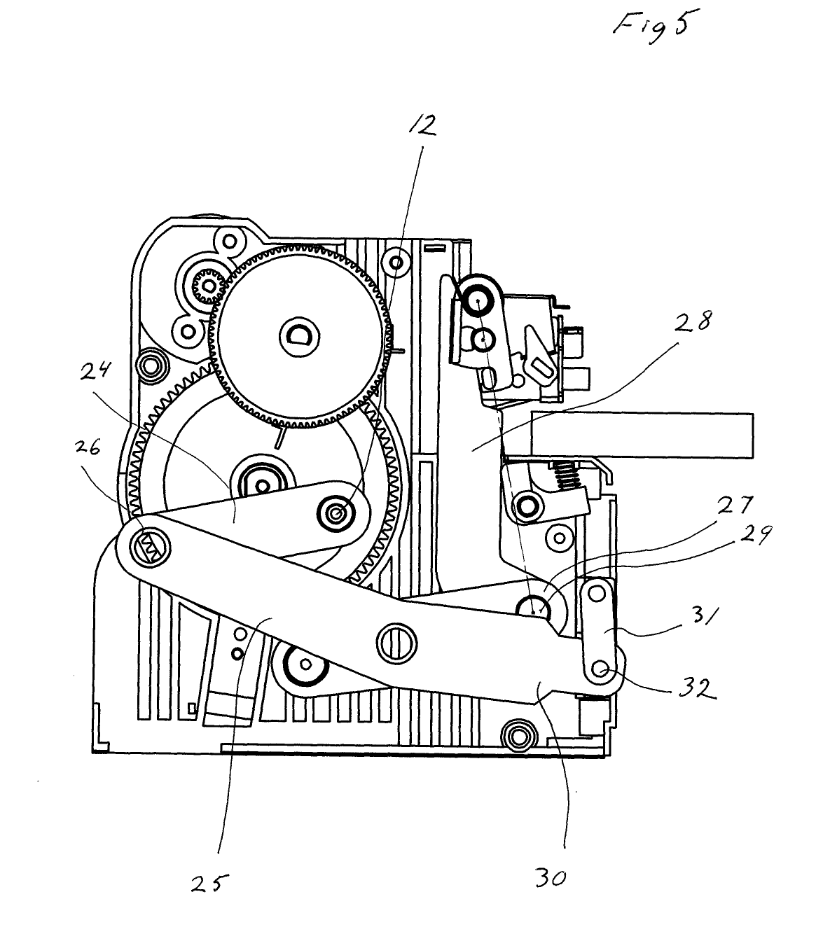

With reference to FIG. 2, the stapler comprises also a link arrangement 13 between the drive device, the anvil and the driver. The arrangement is provided with a scissors link 14 which comprises a connecting spindle 15, a first arm 16, a second arm 17, a third arm 18 and a fourth arm 19. The first arm 16 is connected pivotably in a known way to a first connecting means 20 mounted on the frame. The second arm 17 is connected pivotably in a known way to the connecting spigot 12 by a second connecting means 21. The third arm 18 is connected pivotably in a known way to the anvil 4 by a third connecting means 22. The fourth arm 19 is connected pivotably in a known way to the driver 6 by a fourth connecting means 23. The arms 16 and 17 are on a first side of the scissors link and the arms 18 and 19 are on a second side of the scissors link which is opposite to the first side. With reference to FIG. 5, the arm 17 is divided into a first element 24 and a second element 25 which are connected together pivotably by a first hinge pin 26. The arm 18 is divided into a third element 27 and a fourth element 28 which are connected together pivotably by a second hinge pin 29, and the arm 19 is divided into a fifth element 30 and a sixth element 31 which are connected together by a third hinge pin 32. As a result of these respective hinge pins, the connecting means of the arms 17-19 do not have to be flexible in the longitudinal direction of the joints to overcome the variations in length which occur during a stapling movement between the respective connecting means and the connecting spindle 15. These variations are overcome in a way known to one skilled in the art by the respective hinge pins undergoing during the stapling movement a change of angle between the joints of the arms which compensates for the change in length effected by the respective joint.

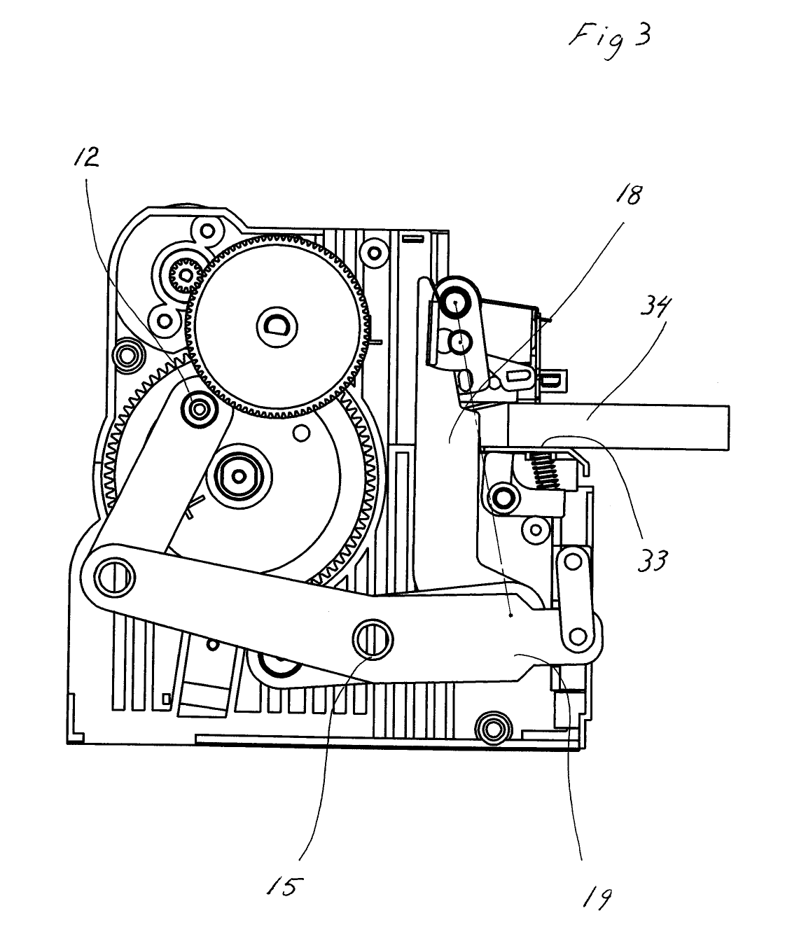

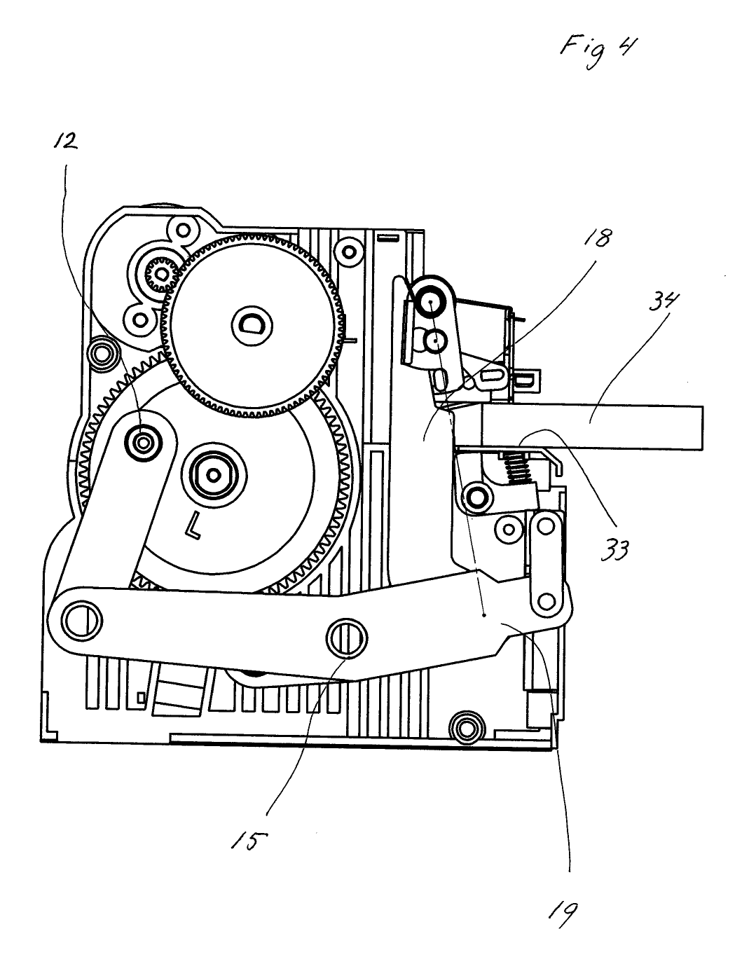

With reference to FIGS. 1-5, the stapler according to the present invention will now be described in the course of a stapling movement in which a workpiece is stapled and the anvil and the driver move towards and away from one another. In FIG. 1 the stapler is in an initial state in which the anvil and the driver are at a maximum distance from one another. The workpiece 34 which is to be stapled is placed on the magazine 5 above the magazine's outlet aperture 33, which does not appear in the drawings. In FIG. 2 the drive means has been activated and the drive device has moved the arm 16 downwards towards the arm 17. In addition, the connecting spindle 15 has also moved downwards and has turned clockwise about the connecting means 20, causing the arm 18 to move the connecting means 22 downwards to a position where the anvil 4 reaches contact with the workpiece 34. In FIGS. 3 and 4 the drive device has moved the arms 16 and 17 further towards one another, with the result that, since the anvil's abutment against the workpiece makes it impossible for the arm 18 to move further downwards, the arm 19 moves upwards and thereby moves the driver 6 towards the anvil. During this movement the anvil and the driver have moved relative to the magazine in opposite directions towards one another, and a staple accommodated in the magazine, not depicted in the drawings but obvious to one skilled in the art, has been driven into the workpiece and has stapled it together. In FIG. 5 the drive device has continued its movement and has driven the arms 16 and 17 away from one another, and the anvil and the driver have moved in opposite directions away from one another. The drive device then continues until the arms assume the positions depicted in FIG. 1.

The fact that the link arrangement is provided with the scissors link 14 affords the advantage of no time delay in the movement pattern of the stapler, and further assurance of this function is afforded by the fact that throughout the stapling movement the means connecting the arm 17 to the drive device is higher in the height direction H than the connecting spindle 15.

The invention is not limited by the above description but only by the claims set out below.

1. A link arrangement (13) forming part of a stapler (1) in which stapling of a workpiece (34) such as a sheaf of papers is effected, which stapler comprises a frame (2) which has attached to it a drive device (7), a staple magazine (5), a driver (6), an anvil (4) and said link arrangement which is connected to and acted upon by the drive device (7) and which in a reciprocating stapling movement (P) imparts to the driver and the anvil relative to the frame a reciprocating movement in which the driver and the anvil move towards and away from one another, characterized in that the link arrangement(13) is provided with a scissors link (14) which comprises a connecting spindle (15) and at least four arms (16-19).

2. A link arrangement (13) according to claim 1, characterized in that the four arms of the scissors link (14) comprise a first arm (16) connected pivotably to the frame (2) and a second arm (17) connected pivotably to the drive device (7), these arms being situated on a first side of the scissors link, and a third arm (18) connected to the anvil (4) and a fourth arm (19) connected to the driver (6), these two latter arms being situated on a second side of the scissors link which is opposite to the first side.

3. A link arrangement (13) according to claim 2, characterized in that the second arm (17) is divided into a first element (24) and a second element (25) which are connected together by a first hinge pin (26).

4. A link arrangement (13) according to claim 2, characterized in that the third arm (18) is divided into a third element (27) and a fourth element (28) which are connected together by a second hinge pin (29).

5. A link arrangement (13) according to claim 2, characterized in that the fourth arm (19) is divided into a fifth element (30) and a sixth element (31) which are connected together by a third hinge pin (32).
